(19) United States
(12) Patent Application Publication
(10) Pub. No.: US 2020/0285168 A1
(43) Pub. Date: Sep. 10, 2020

(54) TONER, TONER STORED CONTAINER, DEVELOPER, DEVELOPER STORED CONTAINER, PROCESS CARTRIDGE, AND IMAGE FORMING APPARATUS

(71) Applicants: Masayuki ISHII, Shizuoka (JP); Shinya Hanatani, Kanagawa (JP)

(72) Inventors: Masayuki ISHII, Shizuoka (JP); Shinya Hanatani, Kanagawa (JP)

(21) Appl. No.: 16/802,336

(22) Filed: Feb. 26, 2020

(30) Foreign Application Priority Data
Mar. 4, 2019 (JP) 2019-038313
Jan. 14, 2020 (JP) 2020-003439

(51) Int. Cl. G03G 9/093; G03G 9/08; G03G 15/08; G03G 21/18

(52) U.S. Cl. CPC G03G 9/09342; G03G 21/1814; G03G 15/0865; G03G 9/0819

(57) ABSTRACT

Provided is a toner including inorganic particles, wherein the inorganic particles include silica and at least one selected from the group consisting of boehmite and pseudoboehmite.

### CROSS-REFERENCE TO RELATED APPLICATIONS

The present application claims priority under 35 U.S.C. § 119 to Japanese Patent Application No. 2019-038313 filed Mar. 4, 2019 and Japanese Patent Application No. 2020-003439 filed Jan. 14, 2020. The contents of which are incorporated herein by reference in their entirety.

### BACKGROUND OF THE INVENTION

### Field of the Invention

The present disclosure relates to a toner, a toner stored container, a developer, a developer stored container, a process cartridge, and an image forming apparatus.

### Description of the Related Art

Conventionally, as inorganic particles of a toner, particles having an average primary particle diameter of from several nanometers through several tens of nanometers are used, and silica subjected to a hydrophobic treatment is used in order to impart charging ability, fluidity, and hydrophobicity. In addition, titanium oxide subjected to a hydrophobic treatment is used in order to maintain charging ability and to prevent variation in a charging amount maintained under conditions of temperature and humidity environments.

In recent years, there is an increased demand for an alternative material of titanium oxide, and alumina, sol-gel silica, strontium titanate, aluminum hydroxide, and the like have been investigated. Moreover, a toner that can include aluminum hydroxide has been proposed (see, for example, Japanese Unexamined Patent Application Publication No. 2005-534967).

### SUMMARY OF THE INVENTION

According to one aspect of the present disclosure, a toner is a toner including inorganic particles and silica. The inorganic particles include silica and at least one selected from the group consisting of boehmite and pseudoboehmite.

### BRIEF DESCRIPTION OF THE DRAWINGS

FIG. 1 is a schematic diagram presenting one example of an image forming apparatus including a process cartridge of the present disclosure;

FIG. 2 is a schematic explanatory diagram presenting one example of an image forming apparatus of the present disclosure;

FIG. 3 is a schematic explanatory diagram presenting another example of an image forming apparatus of the present disclosure;

FIG. 4 is a schematic explanatory diagram presenting one example using a tandem-type color image forming apparatus of the image forming apparatus of the present disclosure;

FIG. 5 is an enlarged view presenting one example of the image forming unit of FIG. 4; and

FIG. 6 is a schematic diagram presenting a curve of electric charge amount distribution of the developer of the present disclosure.

### DESCRIPTION OF THE EMBODIMENTS

### (Toner)

A toner of the present disclosure is a toner that includes inorganic particles. The inorganic particles include silica and at least one selected from the group consisting of boehmite and pseudoboehmite, and further include other components if necessary.

An object of the present disclosure is to provide a toner that has charging stability and can form an image with high quality which has image granularity and image sharpness.

According to the present disclosure, it is possible to provide a toner that has charging stability and can form an image with high quality which has image granularity and image sharpness.

A conventional toner in the art includes aluminum hydroxide and silica, and boehmite can be used as the aluminum hydroxide. However, the fact that boehmite is the most preferable; and the fact that when a toner includes inorganic particles and the inorganic particles include silica and at least one selected from the group consisting of boehmite and pseudoboehmite, it possible to provide a toner that has charging stability and can form an image with high quality which has image granularity and image sharpness, have not been disclosed yet.

As a result of diligent studies performed by the present inventors, it was found that aluminum hydroxide has possibility as an alternative material of titanium oxide in terms of low electric resistance. As aluminum hydroxide, there exist a wide variety of crystal systems (e.g., amorphous bodies, boehmite crystals, pseudoboehmite crystals, gibbsite crystals, bayerite crystals, and diaspore crystals) and mixed crystal systems. However, the pseudoboehmite prevents occurrence of reversely charged particles under an environment, prevents a difference between the electric charge amounts obtained due to environmental conditions, and has an effect of sharpening distribution of the electric charge amount, similarly to the conventional inorganic particles such as titanium oxide. In addition, it was found that the pseudoboehmite has little possibility of scratching the surface of the photoconductor used in the electrophotographic developing system because of its low hardness and satisfies a function of maintaining image quality for a long period of time.

Therefore, the toner of the present disclosure is a toner including inorganic particles.

The inorganic particles include silica and at least one selected from the group consisting of boehmite and pseudoboehmite. As a result, it is possible to adjust the electric charge amount and charging characteristics under environments to thereby achieve excellent charging stability, and to form an image with high quality, where the image has image granularity and image sharpness at the same level as images printed through offset printing. In addition, it is possible to give functions similar to or higher than the conventional functions given by titanium oxide.

A toner of the present disclosure includes inorganic particles, and preferably includes toner base particles.

### <Inorganic Particles>

The inorganic particles include silica and at least one selected from the group consisting of boehmite and pseudoboehmite, and further include other particles if necessary.

### <<Boehmite and Pseudoboehmite>>

The boehmite and the pseudoboehmite are a product obtained by hydrolyzing aluminum alkoxide.

The boehmite is α-type (trigonal system) aluminum oxide monohydrate obtained by dehydrating one molecule of water from aluminum hydroxide.

The pseudoboehmite includes more water component than the boehmite and can be distinguished through X-ray diffraction.

Examples of the product obtained by hydrolyzing aluminum alkoxide include aluminum hydroxide. As the hydrolyzed product, aluminum alkoxide may be at least partially hydrolyzed, and aluminum alkoxide may be entirely hydrolyzed.

The boehmite and the pseudoboehmite are preferably in the form of particles. Examples of a shape of the particles include spherical shapes, acicular shapes, and non-spherical shapes obtained by combining several spherical particles.

The boehmite and the pseudoboehmite each preferably have an average particle diameter (median diameter) of 5 nm or more but 135 nm or less, more preferably have an average particle diameter (median diameter) of 8 nm or more but 120 nm or less.

Measurement of median diameters of the boehmite and the pseudoboehmite is as follows. Specifically, after external addition, a scanning electron microscope SU8200 (Hitachi High-Technologies Corporation) is used to photograph an image at an acceleration voltage of 5 kV and magnification of 50,000× with boehmite or pseudoboehmite adhering to the surface of the toner. The image obtained is subjected to binarization using an image processing software “Azokun” (available from Asahi Kasei Engineering Corporation). From any 1,000 portions of the boehmite or the pseudoboehmite in the image obtained, diameters of perfect circles corresponding to their areas are calculated and then a median diameter thereof is calculated.

Inclusion of the boehmite and the pseudoboehmite having a median diameter of 5 nm or more but 135 nm or less decreases variation in an electric charge amount, fluidity, and aggregation, and deterioration of image quality (e.g., transfer failure and occurrence of an image having greasing) can be prevented. In addition, when the toner including pseudoboehmite having a median diameter of 5 nm or more but 135 nm or less is used, an image with stable image quality can be formed.

An amount of at least one selected from the group consisting of the boehmite and the pseudoboehmite is preferably 0.5 parts by mass or more but 10 parts by mass or less, more preferably 0.5 parts by mass or more but 2.0 parts by mass or less, relative to 100 parts by mass of the toner base particles.

When the amount of at least one selected from the group consisting of the boehmite and the pseudoboehmite is 0.5 parts by mass or more, a difference between electric charge amounts obtained under an environment can be decreased. Moreover, when the amount thereof is 1.0 part by mass or less, a decrease in charging with an amount added can be prevented, and a difference between electric charge amounts obtained under an environment can be prevented.

A method for producing the boehmite and the pseudoboehmite is as follows, for example. For example, an aluminum compound and alcohol are allowed to react to synthesize aluminum alkoxide. Then, the synthesized aluminum alkoxide is hydrolyzed and dried to thereby form the boehmite and the pseudoboehmite.

The aluminum compound is not particularly limited and may be appropriately selected depending on the intended purpose. Examples thereof include aluminum and aluminum oxide.

The alcohol is not particularly limited and may be appropriately selected depending on the intended purpose. Examples thereof include ethyl alcohol, n-propyl alcohol, n-butyl alcohol, n-pentyl alcohol, n-hexyl is alcohol, n-octyl alcohol, 1-dodecanol, dodecyl alcohol, tridecyl alcohol, oleyl alcohol, stearyl alcohol, 2-decyl alcohol, 2-hexyl alcohol, phenylpropanol, and phenylpentanol.

The boehmite and the pseudoboehmite can be analyzed by confirming a peak position obtained through X-ray diffraction and an absorption band obtained through infrared spectroscopy.

The boehmite and the pseudoboehmite are preferably silicon-containing boehmite and silicon-containing pseudoboehmite treated with a silicon compound in terms of charging ability and hydrophobicity.

### Silicon-Containing Boehmite and Silicon-Containing Pseudoboehmite

Examples of the silicon-containing boehmite and the silicon-containing pseudoboehmite include boehmite and pseudoboehmite subjected to a surface treatment with a silicon compound. Examples of the silicon compound include silane coupling agents and silicone oils.

The silane coupling agent is not particularly limited and may be appropriately selected depending on the intended purpose. Examples thereof include alkoxysilanes such as tetramethoxysilane, tetraethoxysilane, methyltrimethoxysilane, methyltriethoxysilane, dimethyldimethoxysilane, dimethyldiethoxysilane, methyldimethoxysilane, methyldiethoxysilane, diphenyldimethoxysilane, isobutyltrimethoxysilane, and decyltrimethoxysilane; silane coupling agents such as γ-aminopropyltriethoxysilane, γ-glycidoxypropyl trimethoxysilane, γ-glycidoxypropyl methyldiethoxysilane, γ-methacryloxypropyltrimethoxysilane , γ-mercaptopropyltrimethoxysilane, vinyltriethoxysilane, and methylvinyldimethoxysilane; vinyltrichlorosilane, dimethyldichlorosilane, methylvinyldichlorosilane, methylphenyldichlorosilane, phenyl trichlorosilane, N,N′-bis(trimethylsilyl)urea, N,O-bis(trimethylsilyl)acetamide, dimethyltrimethylsilylamine, hexamethyldisilazane, and cyclic silazane. These may be used alone or in combination. Among them, hexamethyldisilazane is preferable.

The silicone oil is not particularly limited and may be appropriately selected depending on the intended purpose. Examples thereof include dimethyl silicone oil, methylphenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, methacryl-modified silicone oil, α-methylstyrene-modified silicone oil, polydimethylsiloxane, methylphenyl polysiloxane, methyl hydrogen polysiloxane, methyl trimethicone, methylsiloxane, and methylphenyl siloxane. These may be used alone or in combination. Among them, polydimethylsiloxane is preferable.

### <<Silica<<

Examples of the silica include hydrophobic silica subjected to a hydrophobic treatment.

The hydrophobic silica is not particularly limited and may be appropriately selected depending on the intended purpose. Examples thereof include those treated with a silicon compound. Examples of the silicon compound include those used for a surface treatment of the boehmite and the pseudoboehmite.

### <<Other Particles>>

The other particles are not particularly limited and may be appropriately selected depending on the intended purpose. Examples thereof include: metallic salts of fatty acids such as zinc stearate and calcium stearate; layered double hydroxides such as hydrotalcite; and particles such as strontium titanate, zinc oxide, and tin oxide. These may be used alone or in combination.

### <Toner Base Particles>

The toner base particles preferably include a resin and a colorant, and further include other components if necessary.

### <<Resin>>

The resin is not particularly limited and may be appropriately selected depending on the intended purpose. Examples thereof include; homopolymers of styrene and substitution products thereof such as polystyrene, poly(p-chlorostyrene), and polyvinyltoluene; styrene-based copolymers such as polyester, styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinylmethylether copolymer, styrene-methyl vinyl ketone copolymer, styrene-butadiene copolymer, styrene-isoprene copolymer, and styrene-malate copolymer; polymethyl methacrylate, polybutyl methacrylate, polyvinyl chloride, polyvinyl acetate, polyethylene, polyurethane, epoxy resins, polyvinyl butyral, polyacrylic acids, rosins, modified rosins, terpene resins, phenol resins, aliphatic or aromatic hydrocarbon resins, and aromatic petroleum resins. These may be used alone or in combination. Among them, polyester resins and combinations of an amorphous polyester resin and a crystalline polyester resin are preferable.

### Polyester Resin

The polyester resin is a resin obtained through polycondensation of a multivalent hydroxy compound and polybasic acid.

Examples of the multivalent hydroxy compound include: glycols such as ethylene glycol, diethylene glycol, triethylene glycol, and propylene glycol; alicyclic compounds including two hydroxyl groups such as 1,4-bis(hydroxymethyl)-cyclohexane; and dihydric phenol compounds such as bisphenol A. Note that, the multivalent hydroxy compound also includes compounds having three or more hydroxyl groups.

Examples of the polybasic acid include: dicarboxylic acids such as maleic acid, fumaric acid, phthalic acid, isophthalic acid, terephthalic acid, succinic acid, and malonic acid; and multivalent carboxylic acids that are trivalent or higher, such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylenecarboxypropane, and 1,2,7,8-octanetetracarboxylic acid. These may be used alone or in combination.

The polyester resin can include a monomer that forms an amide component in addition to the above monomer raw materials.

Examples of the monomer that forms an amide component include polyamines such as ethylenediamine, pentamethylenediamine, hexamethylenediamine, phenylenediamine, and triethylenetetramine; and aminocarboxylic acids such as 6-aminocaproic acid and ε-caprolactam. These may be used alone or in combination.

A glass transition temperature (Tg) of the polyester resin is preferably 55° C. or more, more preferably 57° C. or more, in terms of heat resistant storage stability.

### Crystalline Polyester Resin

The crystalline polyester resin is a polyester resin that is obtained by reacting an alcohol component with an acid component and has at least a melting point.

The alcohol component is not particularly limited and may be appropriately selected depending on the intended purpose. Examples thereof include saturated aliphatic diol compounds having 2 or more but 12 or less carbon atoms.

Examples of the saturated aliphatic diol compound having 2 or more but 12 or less carbon atoms include 1,4-butanediol, 1,6-hexanediol, 1,8-octanediol, 1,10-decanediol, 1,12-dodecanediol, and derivatives thereof.

The acid component is not particularly limited and may be appropriately selected depending on the intended purpose. Examples thereof include dicarboxylic acids having 2 or more but 12 or less carbon atoms.

The dicarboxylic acid having 2 or more but 12 or less carbon atoms may be a saturated dicarboxylic acid or may be an unsaturated dicarboxylic acid.

Examples of the dicarboxylic acid having 2 or more but 12 or less carbon atoms include fumaric acid, 1,4-butanedioic acid, 1,6-hexanedioic acid, 1, 8-octanedioic acid, 1,10-decanedioic acid, 1,12-dodecanedioic acid, and derivatives thereof. These may be used alone or in combination.

Use of the crystalline polyester resin prevents a problem such as contamination into a carrier or a charging member due to wax existing on the surface of the toner including toner base particles while a release characteristic during fixing is maintained without deterioration, which makes it possible to achieve excellent results.

An amount of the crystalline polyester is preferably 1 part by mass or more but 30 parts by mass or less relative to 100 parts by mass of the toner base particles. When the amount thereof is less than 1 part by mass, an effect of low temperature fixing ability cannot be sufficiently obtained. When the amount thereof is more than 30 parts by mass, the amount of the crystalline polyester existing on the outermost surface of the toner is excessive, which may result in deterioration of image quality due to contamination of the photoconductor and other members, a decrease in fluidity of the developer, and a decrease in image density. In addition, the surface quality of the toner is deteriorated, the carrier is contaminated, and sufficient charging ability cannot be maintained for a long period of time. Furthermore, there is a risk of inhibiting environmental stability.

Note that, as the resin (toner binder), for example, a compound including the unmodified polyester and a modified polyester (polyester including an ester bond and a binding unit other than the ester bond), a compound including the unmodified polyester and the crystalline polyester, and a compound including the modified polyester, the unmodified polyester, and the crystalline polyester can be optionally selected. In the above formulation, it is important to consider all of the hot offset resistance, the heat resistant storage stability, and the low temperature fixing ability. In the present disclosure, coexistence with a urea-modified polyester as a modified polyester exhibits better heat resistant storage stability compared to known polyester-based toners, even when the glass transition temperature is low.

### <<Colorant>>

The colorant is not particularly limited and may be appropriately selected depending on the intended purpose. Examples thereof include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, p-chloro-o-nitro aniline red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Hello Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS, BC), indigo, ultramarine, Prussian blue, anthraquinone blue, fast violet B, methyl violet lake, cobalt violet, manganese violet, dioxane violet, antraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used alone or in combination.

An amount of the colorant is not particularly limited and may be appropriately selected depending on the intended purpose. The amount thereof is preferably 1 part by mass or more but 15 parts by mass or less, more preferably 3 parts by mass or more but 10 parts by mass or less, relative to 100 parts by mass of the toner base particles.

The colorant may be used as masterbatch composited with a resin. The resin used for the masterbatch is not particularly limited and may be appropriately selected from known products depending on the intended purpose. Examples thereof include homopolymers of styrene or substitution products thereof, styrene-based copolymers, polymethyl methacrylate, polybutyl methacrylate, polyvinyl chloride, polyvinyl acetate, polyethylene, polypropylene, polyester, epoxy resins, epoxy polyol resins, polyurethane, polyamide, polyvinyl butyral, polyacrylic acid, rosins, modified rosins, terpene resins, aliphatic hydrocarbon resins, alicyclic hydrocarbon resins, aromatic petroleum resins, chlorinated paraffin, and paraffin. These may be used alone or in combination.

### <<Other Components>>

The other components are not particularly limited and may be appropriately selected depending on the intended purpose. Examples thereof include a release agent and a charging-controlling agent.

### -Release Agent-

The release agent is not particularly limited and may be appropriately selected depending on the intended purpose. Examples thereof include waxes.

Examples of the waxes include waxes including a carbonyl group, polyolefin waxes, and long chain hydrocarbons. These may be used alone or in combination. Among them, waxes including a carbonyl group are preferable.

Examples of the waxes including a carbonyl group include polyalkanoic acid esters, polyalkanol esters, polyalkanoic acid amide, polyalkylamide, and dialkyl ketone. Among them, polyalkanoic acid esters are preferable.

Examples of the polyalkanoic acid ester include carnauba wax, montan wax, trimethylolpropane tribehenate, pentaerythritol tetrabehenate, pentaerythritol diacetate dibehenate, glycerin tribehenate, and 1,18-octadecanediol distearate.

Examples of the polyalkanol ester include tristearyl trimellitate and distearyl maleate.

Examples of the polyalkanoic acid amide include dibehenyl amide.

Examples of the polyalkylamide include tristearyl trimellitate amide.

Examples of the &alkyl ketone include distearyl ketone.

Examples of the polyolefin wax include polyethylene waxes and polypropylene waxes.

Examples of the long chain hydrocarbon include paraffin waxes and Sasol waxes.

A melting point of the release agent is not particularly limited and may be appropriately selected depending on the intended purpose. However, the melting point thereof is preferably 45° C. or more but 120° C. or less. When the melting point thereof is 45° C. or more, the release agent does not adversely affect heat resistant storage stability. When the melting point thereof is 120° C. or less, cold offset hardly occurs at the timer of fixing at a low temperature.

A melting viscosity of the release agent is preferably 5 cps or more but 1,000 cps or less, more preferably 10 cps or more but 100 cps or less, at a temperature that is higher than the melting point of the release agent by 20° C. When the melting viscosity thereof is 5 cps or more, the release property is improved. When the melting viscosity thereof is 1,000 cps or less, hot offset resistance and low temperature fixing ability are improved.

An amount of the release agent in base particles (coloring particles) is not particularly limited and may be appropriately selected depending on the intended purpose. The amount thereof is preferably 1% by mass or more but 40% by mass or less, more preferably 3% by mass or more but 30% by mass or less. When the amount thereof is 40% by mass or less, fluidity of the toner is improved.

### Charging-Controlling Agent

The charging-controlling agent is not particularly limited and a positive or negative charging-controlling agent may be appropriately selected and used depending on whether charges charged on the photoconductor are positive or negative.

Examples of the negative charging-controlling agent include resins or compounds including an electron-donating functional group, azo dyes, and metal complexes of organic acids. Specific examples thereof include BONTRON (part number: S-31, S-32, S-34, S-36, S-37, S-39, S-40, S-44, E-81, E-82, E-84, E-86, E-88, A, 1-A, 2-A, and 3-A) (all of them are available from ORIENT CHEMICAL INDUSTRIES CO., LTD.), “Kayacharge” (part number: N-1 and N-2), Kayaset Black (part number: T-2 and 004) (all of them are available from Nippon Kayaku Co., Ltd.)), Aizen Spilon Black (T-37, T-77, T-95, TRH, and TNS-2) (all of them are available from Hodogaya Chemical Co., Ltd.), FCA-1001-N, FCA-1001-NB, and FCA-1001-NZ (all of them are available from Fujikura Kasei Co., Ltd.). These may be used alone or in combination.

Examples of the positive charging-controlling agent include basic compounds such as nigrosine dyes, cationic compounds such as quaternary ammonium salts, and metal salts of higher fatty acids. Specific examples thereof include BONTRON (part number: N-01, N-02, N-03, N-04, N-05, N-07, N-09, N-10, N-11, N-13, P-51, P-52, and AFP-B) (all of them are available from ORIENT CHEMICAL INDUSTRIES CO., LTD.), TP-302, TP-415, and TP-4040 (all of them are available from Hodogaya Chemical Co., Ltd.), “Copy Blue PR” and “Copy Charge” (part number: PX-VP-435 and NX-VP-434) (all of them are available from Hoechst), FCA (part number: 201, 201-B-1, 201-B-2, 201-B-3, 201-PB, 201-PZ, and 301) (all of them are available from Fujikura Kasei Co., Ltd.), and PLZ (part number: 1001, 2001, 6001, and 7001) (all of them are available from SHIKOKU CHEMICALS CORPORATION). These may be used alone or in combination.

An amount of the charging-controlling agent added is determined depending on methods for producing coloring particles including kinds of the resin and dispersion methods and is not particularly limited. The amount thereof is preferably 0.05 parts by mass or more but 1.0 part by mass or less relative to the total amount of the resin. When the amount thereof is 1.0 part by mass or less, the charging ability of the toner is appropriate, and an effect of the charging-controlling agent, fluidity of the developer, and image density may be improved. When the amount thereof is 0.05 parts by mass or more, ability to start up charging and an electric charge amount are sufficient, which makes it possible to suppress an influence on a toner image.

### <Production Method of Toner>

A method for producing the toner of the present disclosure is not particularly limited and may be appropriately selected depending on the intended purpose. Examples thereof include the pulverization method, the emulsion polymerization method, the suspension polymerization method, the bulk polymerization method, and the solution polymerization method.

In the pulverization method, toner materials constituting toner base particles are mixed to obtain a mixture. Then, the mixture obtained is melted and kneaded using a melting and kneading machine to thereby obtain a kneaded product.

Examples of the melting and kneading machine include single-screw or twin-screw continuous kneaders and batch-type kneaders using a roll mill. Specific examples thereof include KTK-type twin-screw extruders (available from Kobe Steel, Ltd.), TEM-type extruders (available from TOSHIBA MACHINE CO., LTD.), twin-screw extruders (available from KCK), PCM-type twin-screw extruders (available from Ikegai Corp), and co-kneaders (available from BUSS).

The melting/kneading is preferably performed under appropriate conditions (e.g., temperature of the melting and kneading) so that a molecular chain of the resin is not cleaved. When the temperature of the melting and kneading is much higher than a softening point of the resin, the cleavage may occur severely. When the temperature of the melting and kneading is too low, the melting and kneading may not proceed.

Then, the kneaded product obtained in the melting and kneading is pulverized to obtain a pulverized product. When the kneaded product is pulverized, it is preferable to roughly pulverize the kneaded product, followed by fine pulverization.

Examples of the pulverization method of the kneaded product include: a method by colliding with an impact plate in the jet stream to thereby pulverize the kneaded product; a method by allowing particles to collide with each other in the jet stream; and a method by pulverizing the kneaded product in a narrow gap between a mechanically rotating rotor and a stator.

Furthermore, the pulverized product is classified to adjust the particle diameter to a predetermined range.

Examples of the classification include methods by removing fine particles through cyclone, decanter, or centrifugal separation. Then, a sieve with a size of 250-mesh or larger is used to remove coarse particles and aggregated particles to thereby obtain toner base particles.

In the emulsification method, a liquid including toner materials (oil phase) is emulsified or dispersed in an aqueous medium (aqueous phase) to thereby obtain toner base particles. Specifically, toner particles are obtained after the following steps: a step of dissolving or dispersing, in an organic solvent, toner materials including a resin or a resin precursor, a colorant, and, if necessary, a release agent to thereby prepare a liquid including toner materials (oil phase); and a step of emulsifying or dispersing the oil phase in an aqueous medium (aqueous phase) to thereby remove the solvent.

A volume average particle diameter (Dv) of the toner base particles is preferably 3.0 μm or more but 6.0 μm or less. When the volume average particle diameter (Dv) is 3.0 μm or more, fusing of the toner on a member such as a developing roller or a blade can be prevented in the case of using a one-component developer, and a decrease in charging ability of the carrier caused by fusion of the toner on the surface of the carrier can be prevented in the case of using a two-component developer. When the volume average particle diameter (Dv) is 6.0 μm or less, it is possible to obtain an image with high resolution and high image quality.

A ratio (Dv/Dn) of the volume average particle diameter (Dv) of the toner base particles to the number average particle diameter (Dn) of the toner base particles is preferably 1.05 or more but 1.25 or less. When the ratio (Dv/Dn) is 1.25 or less, it is possible to obtain an image with high resolution and high image quality. When ratio (Dv/Dn) is 1.05 or more, charging ability and cleaning property of the toner become good.

### Toner Stored Container

A toner stored container of the present disclosure is a container storing the toner.

By forming an image using an image forming apparatus in which the toner stored container of the present disclosure is mounted, it is possible to form an image utilizing characteristics of the toner, where the toner has excellent charging stability and can achieve an image with high quality which has image granularity and image sharpness at the same level as images printed through offset printing.

### Developer

The developer of the present disclosure may be a one-component developer including the toner of the present disclosure alone, or may be a two-component developer including the toner of the present disclosure and a carrier. However, when the developer is used in, for example, a high-speed printer compatible with improvement in an information processing speed, the two-component developer is preferably used in terms of, for example, lifetime.

When the toner of the present disclosure is used as the one-component developer, even when the toner is consumed and supplied repeatedly, variation in a particle diameter of the toner is small. Therefore, filming of the toner to a developing roller and fusion of the toner on a member such as a blade configured to thin the layer of the toner are not caused, and it is possible to obtain good and stable developing ability and images even when the developing device is used (stirred) for a long period of time.

In addition, when the toner of the present disclosure is used as the two-component developer, even when the toner is consumed and supplied repeatedly, variation in a particle diameter of the toner is small. Moreover, it is possible to obtain good and stable developing ability even when the developing device is used (stirred) for a long period of time.

### <Carrier>

The carrier is not particularly limited and may be appropriately selected depending on the intended purpose. The carrier preferably includes a core material and a resin layer coating the core material.

A material of the core material is not particularly limited and may be appropriately selected depending on the intended purpose. Examples thereof include manganese-strontium (Mn—Sr)-based materials (50 emu/g or more but 90 emu/g or less), manganese-magnesium (Mn—Mg)-based materials, iron powder (100 emu/g or more), highly magnetized materials such as magnetite (75 emu/g or more but 120 emu/g or less), and low magnetized materials such as copper-zinc (Cu—Zn)-based materials (30 emu/g or more but 80 emu/g or less). These may be used alone or in combination.

In order to ensure image density, highly magnetized materials such as iron powder (100 emu/g or more) and magnetite (75 emu/g or more but 120 emu/g or less) are preferable.

The low magnetized materials (30 emu/g or more but 80 emu/g or less) such as copper-zinc (Cu—Zn)-based materials are preferable because such materials can alleviate an impact on a photoconductor where the toner is in the form of magnetic brush, and are advantageous for improving image quality.

A weight average particle diameter of the core material is preferably 10 μm or more but 200 μm or less, more preferably 40 μm or more but 100 μm or less. When the weight average particle diameter is 10 μm or more, the quantity of fine powder components of the carrier is small. Therefore, magnetization per one particle is high, which can prevent the carrier from being scattered. When the weight average particle diameter is 200 μm or less, the specific surface area is increased, which can prevent the toner from being scattered. As a result, reproducibility of solid portions is particularly good in full-color images having many solid portions.

A material of the resin layer is not particularly limited and may be appropriately selected depending on the intended purpose. Examples thereof include amino-based resins, polyvinyl-based resins, polystyrene-based resins, halogenated olefin resins, polyester-based resins, polycarbonate-based resins, polyethylene, polyvinyl fluoride, polyvinylidene fluoride, polytrifluoroethylene, polyhexafluoropropylene, compolymers of vinylidene fluoride and acryl monomer, compolymers of vinylidene fluoride and vinyl fluoride, fluoroterpolymers such as terpolymers of tetrafluoroethylene, vinylidene fluoride, and non-fluorinated monomer, and silicone resins. These may be used alone or in combination.

Examples of the amino-based resin include urea-formaldehyde resins, melamine resins, benzoguanamine resins, urea resins, polyamide resins, and epoxy resins.

Examples of the polyvinyl-based resin include acrylic resins, polymethyl methacrylate, polyacrylonitrile, polyvinyl acetate, polyvinyl alcohol, and polyvinyl butyral.

Examples of the polystyrene-based resin include polystyrene and styrene-acryl copolymer.

Examples of the halogenated olefin resin include polyvinyl chloride.

Examples of the polyester-based resin include polyethylene terephthalate and polybutylene terephthalate.

A conductive powder may be added to the resin layer if necessary.

Examples of the conductive powder include metal powder, carbon black, titanium oxide, tin oxide, and zinc oxide. An average particle diameter of the conductive powder is preferably 1 μm or less. When the average particle diameter thereof is 1 μm or less, electric resistance is easily controlled.

An amount of the resin layer is preferably 0.01% by mass or more but 5.0% by mass or less relative to the carrier. When the amount thereof is 0.01% by mass or more, a resin layer can be uniformly formed on the surface of the core material. When the amount thereof is 5.0% by mass or less, a thickness of the resin layer is appropriate, and granulation of carriers can be prevented.

A method for forming the resin layer can be performed as follows, is for example. Specifically, a silicone resin and the like is dissolved in a solvent to thereby prepare a coating liquid. Then, the coating liquid is uniformly coated on the surface of the core material through a known coating method, and then is dried and baked to thereby form a resin layer.

The solvent is not particularly limited and may be appropriately selected depending on the intended purpose. Examples thereof include toluene, xylene, methyl ethyl ketone, methyl isobutyl ketone, methyl cellosolve, and butyl acetate.

Examples of the method for coating the coating liquid include the dipping method, the spray method, and the blush coating method.

The baking method may be an external heating system or an internal heating system. Examples thereof include: methods using, for example, a fixed electric furnace, a fluid-type electric furnace, a rotary-type electric furnace, and a burner furnace; and methods using microwaves.

As a mixing ratio between the toner of the present disclosure and the carrier in a two-component developer, 1 part by mass or more but 10 parts by mass or less of the toner relative to 100 parts by mass of the carrier is preferable.

### (Developer Stored Container)

A developer stored container is a container storing the developer of the present disclosure.

Here, one embodiment of the developer stored container is, for example, a developing device, a process cartridge, or the like.

The developing device is one including a unit that stores the developer and is configured to perform developing.

Regarding the developer stored container of the present disclosure, when an image is formed through electrophotography using the developer of the present disclosure stored in the container, an image with high quality can be formed using the toner that achieves excellent cleaning property, image quality, and durability.

### Process Cartridge

A process cartridge of the present disclosure at least includes an electrostatic latent image bearer configured to bear an electrostatic latent image; and a developing unit containing a developer and configured to develop, using the developer, the electrostatic latent image born on the electrostatic latent image bearer to form a visible image, and further includes other units appropriately selected depending on the intended purpose.

The developing unit includes at least a developer stored container storing the toner or the developer of the present disclosure, and a developer bearer configured to bear and convey the toner or the developer stored in the developer stored container, and may further include, for example, a layer thickness regulating member configured to regulate a thickness of the toner layer to be born.

The process cartridge of the present disclosure can be detachably mounted in various image forming apparatuses, and is preferably detachably mounted in an image forming apparatus of the present disclosure that will be described hereinafter.

The process cartridge of the present disclosure is excellent in convenience, and use of the toner of the present disclosure makes it possible to form an image with high quality using the toner that achieves excellent cleaning property, image quality, and durability.

The toner of the present disclosure can achieve excellent effects even when it is loaded into an image forming apparatus including a process cartridge to form an image. That is, a process cartridge that makes image quality excellent can be provided by using the toner of the present disclosure.

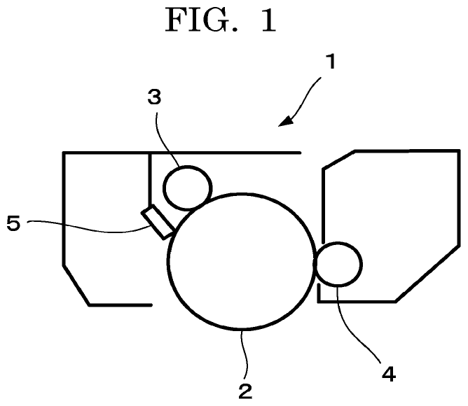

Here, FIG. 1 is a schematic diagram presenting one example of a process cartridge of the present disclosure. A process cartridge 1 of FIG. 1 includes a photoconductor 2, a charging unit 3, a developing unit 4, and a cleaning unit 5.

In an image forming apparatus including the process cartridge, the photoconductor 2 is rotated and driven at a predetermined circumferential speed.

In the rotation process, the photoconductor 2 bears uniformly positive or negative charges having a predetermined electric potential around the peripheral surface by the charging unit 3. Then, the photoconductor 2 is exposed to image-exposing light from an exposing unit such as slit exposure or laser beam scanning exposure to thereby subsequently form an electrostatic latent image around the peripheral surface of the photoconductor 2. The formed electrostatic latent image is then developed with a toner by the developing unit 4, and the developed toner image is subsequently transferred by a transfer unit on a recording medium, which is fed between the photoconductor and the transfer unit by a paper feeding unit in synchronization with rotation of the photoconductor.

The recording medium on which the image has been transferred is separated from the surface of the photoconductor and is introduced into a fixing unit to fix the image. Then, it is printed out as a copied product (copy) into the outside of an apparatus.

On the surface of the photoconductor after the transfer, the remaining toner after the transfer is removed by the cleaning unit 5 for cleaning the surface thereof, and then electricity is further eliminated. Then, the photoconductor is repeatedly used for image formation.

### (Image Formation Method and Image Forming Apparatus)

An image formation method of the present disclosure includes: an electrostatic latent image forming step of forming an electrostatic latent image on an electrostatic latent image bearer; a developing step of developing the electrostatic latent image using the developer of the present disclosure to form a visible image; a transfer step of transferring the visible image on a recording medium; and a fixing step of fixing an image transferred on the recording medium, and further includes other steps appropriately selected depending on the intended purpose. Examples of the other steps include a charge-eliminating step, a cleaning step, a recycling step, and a controlling step.

An image forming apparatus of the present disclosure includes: an electrostatic latent image bearer; an electrostatic latent image forming unit configured to form an electrostatic latent image on the electrostatic latent image bearer; a developing unit containing the developer of the present disclosure and configured to develop the electrostatic latent image using the developer to form a visible image; a transfer unit configured to transfer the visible image on a recording medium; and a fixing unit configured to fix an image transferred on the recording medium. The image forming apparatus of the present disclosure further includes other units appropriately selected depending on the intended purpose. Examples of the other units include a charge-eliminating unit, a cleaning unit, a recycling unit, and a controlling unit.

### <Electrostatic Latent Image Forming Step and Electrostatic Latent Image Forming Unit>

The electrostatic latent image forming step is a step of forming an electrostatic latent image on an electrostatic latent image bearer.

A material, shape, structure, and size of the electrostatic latent image bearer (may be also referred to as “electrophotographic photoconductor” or “photoconductor”) are not particularly limited and may be appropriately selected from materials, shapes, structures, and sizes known in the art. A preferable example of the shape of the photoconductor is drum-shaped. Examples of the material of the photoconductor include: inorganic photoconductors, such as amorphous silicon and selenium; and organic photoconductors (OPC), such as polysilane and phthalopolymethine. Among them, an organic photoconductor (OPC) is preferable because an image with higher resolution can be obtained.

For example, formation of the electrostatic latent image can be performed by uniformly charging a surface of the electrostatic latent image bearer, followed by exposing the surface of the electrostatic latent image bearer to light imagewise. The formation of the electrostatic latent image can be performed by an electrostatic latent image forming unit. For example, the electrostatic latent image forming unit includes at least a charging unit (charger) configured to uniformly charge the surface of the electrostatic latent image bearer, and an exposing unit (exposure device) configured to expose the surface of the electrostatic latent image bearer to light imagewise.

For example, the charging can be performed by applying voltage to the surface of the electrostatic latent image bearer using the charger.

The charger is not particularly limited and may be appropriately selected depending on the intended purpose. Examples of the charger include contact chargers known in the art, equipped with a conductive or semiconductive roller, brush, film, or rubber blade, and non-contact chargers utilizing corona discharge, such as corotron and scorotron.

The charger is preferably a charger that is disposed in contact with or without contact with the electrostatic latent image bearer and is configured to superimpose DC voltage and AC voltage to charge the surface of the electrostatic latent image bearer.

Moreover, the charger is preferably a charging roller disposed adjacent to the electrostatic latent image bearer via a gap tape without being in contact with the electrostatic latent image bearer, where a surface of the electrostatic latent image bearer is charged by applying superimposed DC and AC voltages to the charging roller.

The exposure can be performed by exposing the surface of the electrostatic latent image bearer to light imagewise using the exposure device.

The exposure device is not particularly limited and may be appropriately selected depending on the intended purpose, so long as the exposure device can expose a surface of the electrostatic latent image bearer charged by the charger to light that is in the shape of an image to be formed. Examples of the exposure device includes various exposure devices, such as reproduction optical exposure devices, rod-lens array exposure devices, laser optical exposure devices, and liquid crystal shutter optical devices.

In the present disclosure, a back light system configured to perform exposure imagewise from a back side of the electrostatic latent image bearer may be employed.

### <Developing Step and Developing Unit>

The developing step is a step of developing the electrostatic latent image using the toner to form a visible image.

For example, formation of the visible image can be performed by developing the electrostatic latent image using the toner and can be performed by the developing unit.

For example, the developing unit is suitably a developing unit that stores the toner and includes at least a developing device capable of applying the toner to the electrostatic latent image in contact with the electrostatic latent image or without being in contact with the electrostatic latent image. The developing unit is more preferably a developing device equipped with a toner stored container.

The developing device may be a developing device for a single color or a developing device for multiple colors. Preferable examples of the developing device include a developing device including a stirrer configured to stir the toner to cause friction to charge the toner, and a rotatable magnetic roller.

In the developing device, for example, the toner and the carrier are mixed and stirred to cause friction, the toner is charged by the friction, and the charged toner is held on a surface of the rotating magnetic roller in the form of a brush to thereby form a magnetic brush. Since the magnet roller is disposed adjacent to the electrostatic latent image bearer (photoconductor), part of the toner constituting the magnetic brush formed on the surface of the magnetic roller is transferred onto a surface of the electrostatic latent image bearer (photoconductor) by electric attraction force. As a result, the electrostatic latent image is developed using the toner to form a visible image formed of the toner on the surface of the electrostatic latent image bearer (photoconductor).

### <Transfer Step and Transfer Unit>

The transfer step is a step of transferring the visible image to a recording medium. A preferable embodiment of the transfer step is a step of primarily transferring a visible image onto an intermediate transfer member using the intermediate transfer member and then secondarily transferring the visible image onto the recording medium. A more preferable embodiment of the transfer step is a step, which uses toners of two or more colors, preferably full-color toners as the toner, and which includes: a primary transfer step of transferring visible images onto an intermediate transfer member to form a composite transfer image; and a secondary transfer step of transferring the composite transfer image onto a recording medium.

The transferring can be performed by charging the visible image on the electrostatic latent image bearer (photoconductor) using a transfer charger. The transferring can be performed by the transfer unit. A preferable embodiment of the transfer unit is a transfer unit including a primary transfer unit configured to transfer visible images onto an intermediate transfer member to form a composite transfer image and a secondary transfer unit configured to transfer the composite transfer image onto a recording medium.

Note that, the intermediate transfer member is not particularly limited and may be appropriately selected from transfer members known in the art depending on the intended purpose. Preferable examples of the intermediate transfer member include a transfer belt.

The transfer unit (the primary transfer unit or the secondary transfer unit) preferably includes at least a transfer device configured to charge the visible image formed on the electrostatic latent image bearer (photoconductor) to release the visible image to the side of the recording medium. The number of the transfer devices may be one, or two or more. Examples of the transfer device include a corona transfer device using corona discharge, a transfer belt, a transfer roller, a pressure-transfer roller, and an adhesion-transfer device.

Note that, the recording medium is not particularly limited and may be appropriately selected from recording media (recording paper) known in the art.

### <Fixing Step and Fixing Unit>

The fixing step is a step of fixing the visible image transferred onto the recording medium using a fixing device. The fixing step may be performed every time when the developer of each color is transferred onto the recording medium, or may be performed at the same time once when the developers of all colors are laminated.

The fixing device is not particularly limited and may be appropriately selected depending on the intended purpose. The fixing device is preferably a heat-press unit known in the art. Examples of the heat-press unit include a combination of a heating roller and a press roller, and a combination of a heat roller, a press roller, and an endless belt.

The fixing device is preferably a unit that includes a heating body equipped with a heat generator, a film in contact with the heating body, and a press member pressed against the heating body via the film, and is configured to pass a recording medium on which an unfixed image is formed through between the film and the press member to heat-fixing the image onto the recording medium. Heating performed by the heat-press unit is generally preferably performed at 80° C. or more but 200° C. or less.

In the present disclosure, in combination with or instead of the fixing step and the fixing unit, for example, a photofixing device known in the art may be used depending on the intended purpose.

### <Other Steps and Other Units>

The charge-eliminating step is a step of applying charge-elimination bias to the electrostatic latent image bearer to eliminate the charge of the electrostatic latent image bearer. The charge-eliminating step can be suitably performed by a charge-eliminating unit.

The charge-eliminating unit is not particularly limited so long as the charge-eliminating unit is capable of applying charge-elimination bias to the electrostatic latent image bearer. The charge-eliminating unit may be appropriately selected from charge eliminators known in the art. Examples of the charge-eliminating unit include charge-eliminating lamps.

The cleaning step is a step of removing the toner remaining on the electrostatic latent image bearer. The cleaning step is suitably performed by a cleaning unit.

The cleaning unit is not particularly limited so long as the cleaning unit is capable of removing the toner remaining on the electrostatic latent image bearer. The cleaning unit is appropriately selected from cleaners known in the art. Preferable examples of the cleaner include magnetic-brush cleaners, electrostatic-brush cleaners, magnetic-roller cleaners, blade cleaners, brush cleaners, and web cleaners.

The recycling step is a step of recycling the toner removed by the cleaning step to the developing unit. The recycling unit is suitably performed by a recycling unit. The recycling unit is not particularly limited, and examples of the recycling unit include conveying units known in the art.

The controlling step is a step of controlling each of the above-described steps. Each step can be suitably performed by the controlling unit.

The controlling unit is not particularly limited and may be appropriately selected depending on the intended purpose, so long as the controlling unit is capable of controlling operations of each of the above-mentioned units. Examples of the controlling unit include devices such as sequencers and computers.

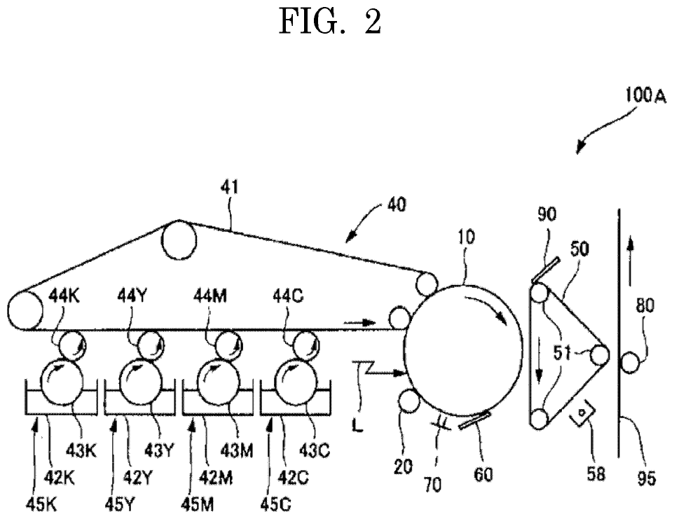

One example of the image forming apparatus of the present disclosure is illustrated in FIG. 2. An image forming apparatus 100A includes a photoconductor drum 10, a charging roller 20, an exposing device, a developing device 40, an intermediate transfer belt 50, a cleaning device 60 including a cleaning blade, and a charge-eliminating lamp 70.

The intermediate transfer belt 50 is an endless belt that is supported with three rollers 51 disposed at the inner side of the intermediate transfer belt 50. The intermediate transfer belt 50 can be moved in the direction indicated with an arrow in FIG. 2. Part of the three rollers 51 also functions as a transfer bias roller capable of applying transfer bias (primary transfer bias) to the intermediate transfer belt 50. Moreover, a cleaning device 90 having a cleaning blade is disposed adjacent to the intermediate transfer belt 50. Furthermore, a transfer roller 80 is disposed so as to face the intermediate transfer belt 50. The transfer roller 80 is capable of applying transfer bias (secondary transfer bias) for transferring a toner image to transfer paper 95.

In the surrounding area of the intermediate transfer belt 50, a corona-charging device 58 configured to apply charge to the toner image transferred to the intermediate transfer belt 50 is disposed between a contact area of the photoconductor drum 10 and the intermediate transfer belt 50 and a contact area of the intermediate transfer belt 50 and the transfer paper 95 relative to a rotational direction of the intermediate transfer belt 50.

The developing device 40 includes: a developing belt 41; and a black-developing unit 45K, a yellow-developing unit 45Y, a magenta-developing unit 45M, and a cyan-developing unit 45C disposed in the surrounding area of the developing belt 41. Note that, the developing unit 45 of each color includes a developer housing portion 42, a developer-supply roller 43, and a developing roller (developer bearer) 44. Moreover, the developing belt 41 is an endless belt supported by a plurality of belt rollers and is movable in the direction indicated with the arrow in FIG. 2. Moreover, part of the developing belt 41 is in contact with the photoconductor drum 10.

Next, a method for forming an image using the image forming apparatus 100A will be explained. First, a surface of the photoconductor drum 10 is uniformly charged using the charging roller 20, followed by applying exposure light L to the photoconductor drum 10 using an exposing device (not illustrated) to form an electrostatic latent image. Next, the electrostatic latent image formed on the photoconductor drum 10 is developed with a toner supplied from the developing device 40 to form a toner image. Moreover, the toner image formed on the photoconductor drum 10 is transferred (primary transfer) onto the intermediate transfer belt 50 by transfer bias applied from the roller 51, and then transferring the toner image (secondary transfer) onto transfer paper 95 by transfer bias applied from the transfer roller 80. Meanwhile, the toner remaining on the surface of the photoconductor drum 10, from which the toner image has been transferred to the intermediate transfer belt 50, is removed by the cleaning device 60, followed by eliminating the charge from the surface using the charge-eliminating lamp 70.

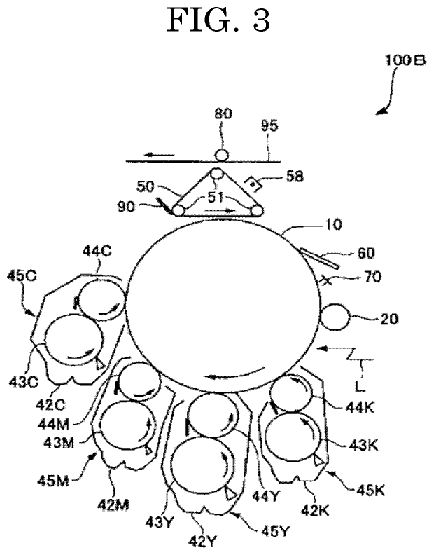

A second example of the image forming apparatus used in the present disclosure is illustrated in FIG. 3. An image forming apparatus 100B has the same configuration as the configuration of the image forming apparatus 100A, except that the developing belt 41 is not disposed, and the black-developing unit 45K, the yellow-developing unit 45Y, the magenta-developing unit 45M, and the cyan-developing unit 45C are directly disposed in the periphery of the photoconductor drum 10.

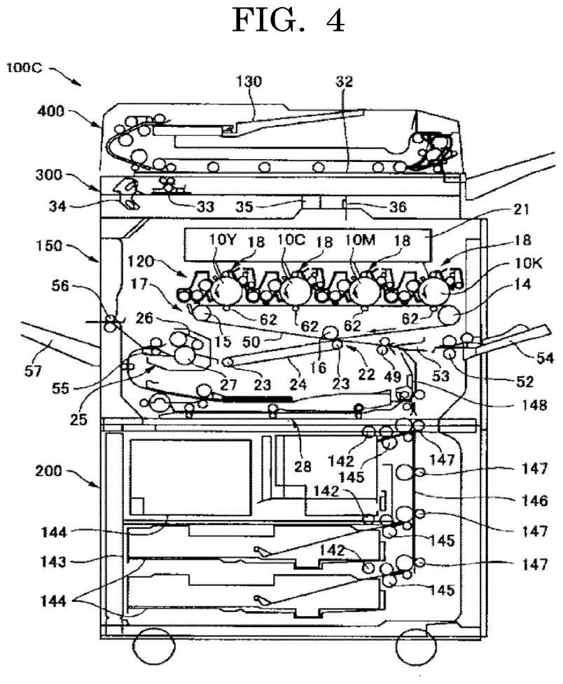

A third example of the image forming apparatus used in the present disclosure is illustrated in FIG. 4. An image forming apparatus 100C is a tandem color-image forming apparatus and includes a photocopier main body 150, a paper-feeding table 200, a scanner 300, and an automatic document feeder (ADF) 400.

An intermediate transfer belt 50 disposed in a central area of the photocopier main body 150 is an endless belt supported by three rollers 14, 15, and 16. The intermediate transfer belt 50 can be moved in the direction indicated with the arrow in FIG. 4. A cleaning device 17 having a cleaning blade configured to remove a toner remaining on the intermediate transfer belt 50, from which a toner image has been transferred to recording paper, is disposed adjacent to the roller 15. A yellow image forming unit 120Y, a cyan image forming unit 120C, a magenta image forming unit 120M, and a black image forming unit 120K are aligned along the conveying direction, and also face the intermediate transfer belt 50 supported by the rollers 14 and 15.

Moreover, an exposing device 21 is disposed adjacent to the image forming unit 120. Furthermore, a secondary-transfer belt 24 is disposed at the side of the intermediate transfer belt 50 opposite to the side where the image forming unit 120 is disposed. Note that, the secondary-transfer belt 24 is an endless belt supported by a pair of rollers 23, and recording paper conveyed on the secondary-transfer belt 24 and the intermediate transfer belt 50 can be brought into contact with each other between the rollers 16 and 23.

Moreover, a fixing device 25 is disposed adjacent to the secondary-transfer belt 24. The fixing device 25 includes a fixing belt 26 that is an endless belt supported by a pair of rollers, and a press roller 27 disposed to be pressed against the fixing belt 26. Note that, a sheet reverser 28 configured to reverse recording paper when images are formed on both sides of the recording paper is disposed adjacent to the secondary-transfer belt 24 and the fixing device 25.

Next, a method for forming a full-color image using the image forming apparatus 100C will be explained. First, a color document is set on a document table 130 of the automatic document feeder (ADF) 400. Alternatively, the automatic document feeder 400 is opened, a color document is set on a contact glass 32 of a scanner 300, and then the automatic document feeder 400 is closed. In the case where the document is set on the automatic document feeder 400, once a start switch is pressed, the document is conveyed to the contact glass 32, and then the scanner 300 is driven to scan the document with a first carriage 33 equipped with a light source and a second carriage 34 equipped with a mirror. In the case where the document is set on the contact glass 32, the scanner 300 is immediately driven in the same manner as described above. The reflected light from the surface of the document, which is light emitted from the first carriage 33, is reflected by the second carriage 34, and then the reflected light is received by a reading sensor 36 via an imaging forming lens 35. Then, the document is read to thereby obtain image information of black, yellow, magenta, and cyan.

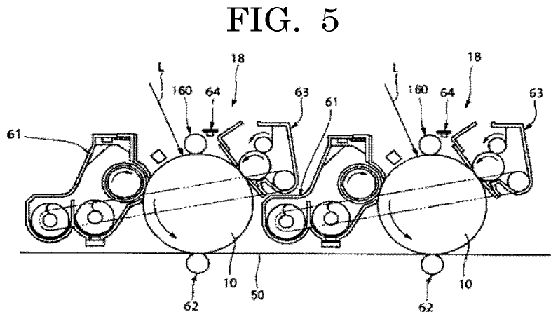

Image information of each color is transmitted to a corresponding image forming unit 120 to form a toner image of each color. As illustrated in FIG. 5, the image forming unit 120 of each color includes a photoconductor drum 10, a charging roller 160 configured to uniformly charge the photoconductor drum 10, an exposing device configured to apply exposure light L to the photoconductor drum 10 based on the image information of each color to form an electrostatic latent image of each color, a developing device 61 configured to develop the electrostatic latent image with a developer of each color to form a toner image of each color, a transfer roller 62 configured to transfer the toner image onto the intermediate transfer belt 50, a cleaning device 63 having a cleaning blade, and a charge-eliminating lamp 64. The single-color toner images formed by the image forming units 120 of the above-mentioned colors are sequentially transferred (primary transfer) onto the intermediate transfer body 50 moving with being supported by the rollers 14, 15, and 16, and the single-color toner images are superimposed to thereby form a composite toner image. Meanwhile, one of paper feeding rollers 142 of the paper feeding table 200 is selectively rotated to feed sheets from one of vertically stacked paper feeding cassette 144 housed in a paper bank 143. The sheets are separated one another by a separation roller 145. The separated sheet is fed to a paper feeding path 146, and then conveyed by a conveyance roller 147 to guide the sheet to a paper feeding path 148 in the photocopier main body 150. Then, the sheet is stopped at a registration roller 49. Alternatively, paper feeding rollers are rotated to feed sheets of the recording paper on a bypass feeder 54. The sheets are separated one another by a separation roller 52. The separated sheet is guided to a manual paper feeding path 53, and is stopped at the registration roller 49.

Note that, the registration roller 49 is generally earthed at the time of use, but the registration roller 49 may be used in a state that bias is applied in order to remove paper dusts of recording paper. Next, the registration roller 49 is rotated in synchronization with the movement of the composite toner image formed on the intermediate transfer belt 50, to thereby send the recording paper between the intermediate transfer belt 50 and the secondary-transfer belt 24. The composite toner image is transferred (secondary transfer) on the recording paper. Note that, the toner remaining on the intermediate transfer belt 50, from which the composite toner image has been transferred, is removed by the cleaning device 17.

The recording paper, onto which the composite toner image has been transferred, is conveyed by the secondary-transfer belt 24 and then the composite toner image is fixed by the fixing device 25. Next, the traveling path of the recording paper is switched by a switch craw 55 and the recording paper is ejected onto a paper ejection tray 57 by an ejecting roller 56. Alternatively, the traveling path of the recording paper is switched by the switch craw 55 and the recording paper is reversed by the sheet reverser 28. After an image is formed on the rear of the recording paper in the same manner, the recording paper is ejected onto the paper ejection tray 57 by the ejection roller 56.

According to the image forming apparatus and the image formation method of the present disclosure, it is possible to form an image with high quality for a long period of time because the toner of the present disclosure is used which has excellent charging stability and can form an image with high quality, where the image has image granularity and image sharpness at the same level as images printed through offset printing.

### EXAMPLE

Hereinafter, the present disclosure will be described by way of Examples. However, the present disclosure should not be construed as being limited to these Examples.

### Preparation Example of Pseudoboehmite

Aluminum alkoxide was synthesized by reacting metal aluminum with alcohol, and the aluminum alkoxide was hydrolyzed to thereby obtain hydrated alumina having a pseudoboehmite structure. At this time, pseudoboehmite A (8 nm), pseudoboehmite B (120 nm), pseudoboehmite C (5 nm), and pseudoboehmite D (135 nm) different in an average particle diameter (median diameter) were obtained by changing the production conditions.

### Preparation Example 1 of Inorganic Particles

### Preparation of Pseudoboehmite AA

The pseudoboehmite A was subjected to a surface treatment with polydimethylsiloxane to thereby obtain pseudoboehmite AA.

### Preparation Example 2 of Inorganic Particles

### Preparation of Pseudoboehmite AB

Pseudoboehmite AB was obtained in the same manner as in the Preparation Example 1 of inorganic particles except that the pseudoboehmite A was changed to the pseudoboehmite B and the pseudoboehmite B was subjected to a surface treatment with hexamethyldisilazane.

### Preparation Example 3 of Inorganic Particles

### Preparation of Pseudoboehmite AC

Pseudoboehmite AC was obtained in the same manner as in the Preparation Example 1 of inorganic particles except that the pseudoboehmite A was changed to the pseudoboehmite C.

### Preparation Example 4 of Inorganic Particles

### Preparation of Pseudoboehmite AD

Pseudoboehmite AD was obtained in the same manner as in the Preparation Example 1 of inorganic particles except that the pseudoboehmite A was changed to the pseudoboehmite D and the pseudoboehmite B was subjected to a surface treatment with hexamethyldisilazane.

### (Preparation Example of Amorphous Aluminum Hydroxide)

### -Preparation of Amorphous Aluminum Hydroxide A-

A sodium hydroxide solution was added to an aqueous aluminum chloride solution. Precipitations were generated at pH 8 and were aged in the mother liquid for 24 hours to thereby obtain amorphous aluminum hydroxide A.

### Preparation Example 5 of Inorganic Particles

### Preparation of Amorphous Aluminum Hydroxide BA

The amorphous aluminum hydroxide A was subjected to a surface treatment with polydimethylsiloxane to thereby obtain amorphous aluminum hydroxide BA. Note that, the amorphous aluminum hydroxide has an amorphous crystal phase, and is different from boehmite and pseudoboehmite.

### Preparation Example of Bayerite

### Preparation of Bayerite B

A sodium hydroxide solution was added to an aqueous aluminum chloride solution. Precipitations were generated at pH 11 and were aged in the mother liquid for 24 hours to thereby obtain bayerite B.

### Preparation Example 6 of Inorganic Particles

### Preparation of Bayerite BB

The bayerite B was subjected to a surface treatment with polydimethylsiloxane to thereby obtain bayerite BB.

Note that, bayerite is β-type (hexagonal system) aluminum oxide trihydrate, and is different from boehmite and pseudoboehmite in terms of crystal phase and the number of hydrates.

### Preparation Example of Hydrargillite

### Preparation of Hydrargillite C

A sodium hydroxide solution was added to an aqueous aluminum chloride solution. Precipitations were generated at pH 12 and were aged in the mother liquid for 24 hours to thereby obtain hydrargillite C.

### Preparation Example 7 of Inorganic Particles

### Preparation of Hydrargillite BC

The hydrargillite C was subjected to a surface treatment with hexamethyklisilazane to thereby obtain hydrargillite BC.

Note that, hydrargillite is α-type (trigonal system) aluminum oxide trihydrate, and is different from boehmite and pseudoboehmite in terms of the number of hydrates.

### Production Example of Crystalline Polyester

A four-neck flask having capacity of 5 L, which had been equipped with a nitrogen-introducing tube, a dehydration tube, a stirrer, and a thermocouple, was charged with 1,10-decanedioic acid (2,300 g), 1,8-octanediol (2,530 g), and hydroquinone (4.9 g). The resultant was allowed to react at 180° C. for 10 hours, and then was allowed to react at 200° C. for 3 hours, followed by additional reaction at 8.3 kPa for 2 hours. Then, measurement was performed through the contact point method of the DSC measurement. A crystalline polyester resin A having a glass transition temperature (Tg) of 65° C., a melting point peak temperature of 70° C., a weight average molecular weight (Mw) of 10,000, a number average molecular weight (Mn) of 3,000, and Mw/Mn of 3.3 was obtained. The crystalline polyester resin A obtained was analyzed using a crystal analysis X-ray diffraction apparatus. Among the peaks obtained in the range of the diffraction peak of 20°<2θ<25° , the peak half value width of the peak having the highest peak intensity was 0.5.

### Production Example 1 of Amorphous Polyester Resin

A four-neck flask having capacity of 5 L, which had been equipped with a thermometer, a stirrer, and a condenser, was charged with fumaric acid (18.4 parts by mass), trimellitic anhydride (10.5 parts by mass), ethylene oxide adduct of bisphenol A (2.2 mol of ethylene oxide added) (34.2 parts by mass), and propione oxide adduct of bisphenol A (2.2 mol of propione oxide added) (36.8 parts by mass) (4,000 g in total). The flask was set in a mantle heater, and dibutyltin oxide (4 parts by mass) was added thereto, followed by reaction at 220° C. for 8 hours. Then, the resultant was allowed to react at 8.3 kPa until it reached a predetermined softening temperature to thereby obtain amorphous polyester resin B-H1.

### Production Example 2 of Amorphous Polyester Resin

A four-neck flask having capacity of 5 L, which had been equipped with a thermometer, a stirrer, and a condenser, was charged with fumaric acid (16.9 parts by mass), terephthalic acid (10.4 parts by mass), and propione oxide adduct of bisphenol A (2.2 mol of propione oxide added) (72.7 parts by mass) (4,000 g in total). The flask was set in a mantle heater, and dibutyltin oxide (4 parts by mass) was added thereto, followed by reaction at 220° C. for 8 hours. Then, the resultant was allowed to react at 8.3 kPa until it reached a predetermined softening temperature to thereby obtain amorphous polyester resin B-L1.

Table 1 presents physical property values of the amorphous polyester resins B-H1 and B-L1.

TABLE 1

| | | Amorphous | |
|---|---|---|---|
| | | polyester resin | |
| | | B-H1 | B-L1 |
| Acid | Fumaric acid | 18.4 | 16.9 |
| component | Trimellitic anhydride | 10.5 | — |
| | Terephthalic acid | — | 10.4 |
| Alcohol | Ethylene oxide adduct of bisphenol A | 34.2 | — |
| component | (2.2 mol of ethylene oxide added) | | |
| | Propione oxide adduct of bisphenol A | 36.8 | 72.7 |
| | (2.2 mol of propione oxide added) | | |
| | Dibutyltin oxide | 4 | 4 |

| | | |
|---|---|---|
| Flow tester 1/2 flowing-out beginning temperature | 148 | 94 |
| (° C.) | | |
| Contact point method Tg (° C.) | 60 | 51 |
| Number average molecular weight (Mn) | 2053 | 2900 |
| Weight average molecular weight (Mw) | 77730 | 5960 |

### Example 1

[Toner materials]

| | | |
|---|---|---|
| Crystalline polyester resin A: | 20 | parts by mass |
| Amorphous polyester resin B-H1: | 20 | parts by mass |
| Amorphous polyester resin B-L1: | 60 | parts by mass |
| Zr salicylate salt (TN-105: available | 1 | part by mass |
| from Hodogaya Chemical Co., Ltd.): | | |
| Carnauba wax from which free fatty | 7 | parts by mass |
| acid is removed (Tg: 83° C.): | | |
| Carbon black (#44: available from | 13 | parts by mass |
| Mitsubishi Chemical Corporation): | | |

The above toner materials were mixed upon stirring using a Henschel mixer, and were heated and melted using a roll mill at a temperature of from 125° C. through 130° C. for 40 minutes, followed by cooling to room temperature (25° C.). The kneaded product obtained was pulverized and classified using a jet mill to thereby obtain toner base particles A having a volume average particle diameter of 7.0 pm and particle size distribution where particles of 5 μm or less were 35% by number.

### -Kneading Step-

Next, silica (H2000, available from Wacker, volume average particle diameter: 12 nm, treated with hexamethylclisilazane) (1.5 parts by mass) was added to the toner base particles A (100 parts by mass), and was mixed using a Henschel mixer at a rotation speed of a stirring blade of 35 m/second. Then, the pseudoboehmite AA (1 part by mass) was added thereto, and was mixed using a Henschel mixer at a rotation speed of a stirring blade of 35 m/second, to thereby obtain a toner X1.

### Example 2

A toner X2 was obtained in the same manner as in Example 1 except that the rotation speed of the stirring blade of the Henschel mixer in the kneading step was changed from 35 m/second to 55 m/second and the pseudoboehmite AA was changed to the pseudoboehmite AB.

### Example 3

A toner X3 was obtained in the same manner as in Example 1 except that silica (H2000, available from Wacker) was changed to silica (NY50, available from NIPPON AEROSIL CO., LTD., volume average particle diameter: 25 nm, treated with polydimethylsiloxane).

### Example 4

A toner X4 was obtained in the same manner as in Example 2 except that silica (H2000, available from Wacker) was changed to silica (RY300, available from NIPPON AEROSIL CO., LTD., volume average particle diameter: 10 nm, treated with polydimethylsiloxane).

### Example 5

A toner X5 was obtained in the same manner as in Example 1 except that the pseudoboehmite AA was changed to the pseudoboehmite AC.

### Example 6

A toner X6 was obtained in the same manner as in Example 4 except that the pseudoboehmite AB was changed to pseudoboehmite AD.

### Comparative Example 1

A toner Y1 was obtained in the same manner as in Example 1 except that the pseudoboehmite AA was changed to the amorphous aluminum hydroxide BA.

### Comparative Example 2

A toner Y2 was obtained in the same manner as in Example 1 except that the pseudoboehmite AA was changed to the bayerite BB.

### Comparative Example 3

A toner Y3 was obtained in the same manner as in Example 1 except that the pseudoboehmite AA was changed to the hydrargillite BC.

### Production Example 1 of Carrier

A coating solution, which was obtained by dispersing a silicone resin solution (available from Shin-Etsu Chemical Co., Ltd.) (200 parts by mass) and carbon black (available from CABOT) (3 parts by mass) in toluene, was coated on a ferrite core material (2500 parts by mass) through a fluidized bed spraying method to thereby coat the surface of the core material. Then, the resultant was baked for 2 hours in an electric furnace of 300° C. to thereby obtain a carrier. The carrier having a volume average particle diameter (Dv) of 30 μm or more but 60 μm or less was used.

### Preparation of Developer

Each of the toners (7 parts by mass) obtained in Examples 1 to 6 and Comparative Examples 1 to 3 and the carrier (93 parts by mass) were mixed and stirred to thereby obtain developers X1 to X6 and developers Y1 to Y3 each having a toner concentration of 7% by mass.

### <Image Formation>

The developers X1 to X6 in Examples 1 to 6 and the developers Y1 to Y3 in Comparative Examples 1 to 3 were used to form an image using an image forming apparatus, digital full color copying machine (imagioColor 2800, available from RICOH Company, Ltd.).

Then, charging stability, image quality, image granularity and image sharpness, and heat resistant storage stability were evaluated in the following manners. Results were presented in Tables 2 and 3.

### <Charging Stability>

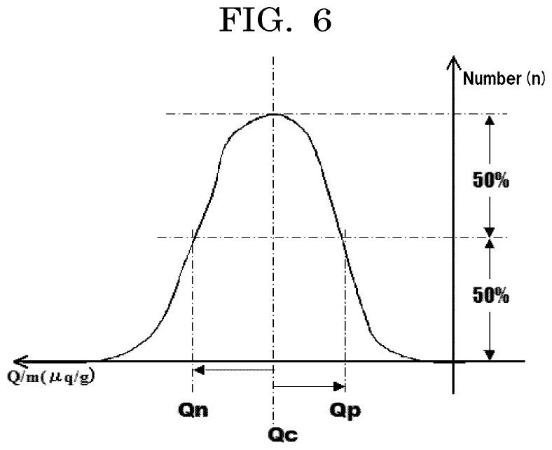

Each developer prepared was used to obtain a curve of electric charge amount distribution of the developer prepared using a blow-off electric charge amount measuring device (device name: TB-200, available from Toshiba Chemical), and E-SAPRT (Model EST-II, available from HOSOKAWA MICRON CORPORATION) (see FIG. 6).

The number of particles N at a peak value Qc (Qc, N) in the obtained curve of electric charge amount distribution was calculated, and points of intersection of N/2 and the curve of electric charge amount distribution were (Qn, N/2) and (Qp, N/2), respectively (Qn<Qp). From the obtained Qn, Qc, and Qb, the following Formula (1) and Formula (2) were used to calculate Wa and Wb.

Wa=|(Qn−Qc)/Qc|×100 . . . Formula (1)

Wb=|(Qp−Qc)/Qc|×100 . . . Formula (2)

The values of Wa and Wb were used to evaluate charging stability of the developer based on the following evaluation criteria.

### [Evaluation Criteria of Charging Stability]

B: Wa and Wb are 20 or less.

C: Wa is 20 or less and Wb is 20 or more, or Wa is 20 or more and Wb is 20 or less.

D: Wa and Wb are 20 or more.

### <Image Quality>

Each developer was used to evaluate image quality (specifically, transfer failure and occurrence of an image having greasing) after sheets of paper were fed.

Regarding the transfer failure, 5,000 sheets of paper were fed using a digital full color copying machine (Imagio Neo C600 modified machine, available from RICOH Company, Ltd.). Then, a black solid image was printed, and a transfer failure level of the image was visually judged.

Regarding the image having greasing, 5,000 sheets of paper were fed using a digital full color copying machine (Imagio Neo C600 modified machine, available from RICOH Company, Ltd.). Then, a white paper image was stopped during the developing, and the developer on the photoconductor after the developing was transferred on a piece of Scotch tape (available from Sumitomo 3M Limited). Image density of the piece of Scotch tape on which the developer was transferred and image density of a piece of Scotch tape on which the developer was untransferred were measured using a spectrum densitometer (product name: available from X-Rite938, available from X-Rite) in order to perform the quantitative evaluation. The difference of less than 0.30 was considered “good”, and the difference of 0.30 or more was considered “bad”.

The image quality determined by combining the transfer failure and the image having greasing was evaluated based on the following evaluation criteria.

### [Evaluation Criteria]

B: The image quality is good.

C: The image quality is not good, but acceptable.

D: The image quality is bad.

### <Image Granularity and Sharpness>

Each developer was used to output a single-color photographic image using a digital full color copying machine (imagioColor2800, available from RICOH Company, Ltd.), and degrees of image granularity and sharpness were visually evaluated.

### [Evaluation Criteria of Image Granularity and Sharpness]

A: The image granularity and the sharpness thereof are similar to those of an image obtained by offset printing, and are good.

B: The image granularity and the sharpness thereof are deteriorated than those of an image obtained by offset printing, but are good.

C: The image granularity and the sharpness thereof are poorer than those of an image obtained by offset printing.

D: The image granularity and the sharpness thereof are similar to those of the conventional electrophotographic image.

### <Heat Resistant Storage Stability>

The heat resistant storage stability was measured using a penetrometer (available from NIKKA ENGINEERING CO., LTD.). Specifically, each toner (10 g) was weighed and was charged into a 30-mL glass container (screw vial) under an environment (temperature of from 20° C. through 25° C., from 40 through 60% RH). Then, a lid was closed. The glass container into which the toner was charged was tapped 100 times, and then was left to stand for 24 hours in a thermostat bath that had been set to a temperature of 50° C. Then, the penetration was measured using a penetrometer and the heat resistant storage stability was evaluated based on the following evaluation criteria. The higher the penetration is, the more excellent the heat resistant storage stability is.

### [Evaluation Criteria]

A: The penetration is 30 mm or more.

B: The penetration is 25 mm or more but less than 30 mm.

C: The penetration is 20 mm or more but less than 25 mm.

D: The penetration is less than 20 mm.

TABLE 2

Example

| | | 1 | 2 | 3 |
|---|---|---|---|---|
| Pseudoboehmite | Name | AA | AB | AA |
| | Average particle | 8 | 120 | 8 |
| | diameter (median | | | |
| | diameter) (nm) | | | |
| | Surface treatment | Polydimethyl- | Hexamethyl- | Polydimethyl- |
| | | siloxane | disilazane | siloxane |
| | Amount relative | 1 | 1 | 1 |
| | to toner base | | | |
| | particles (%) | | | |
| Hydrophobic | Surface treatment | Hexamethyl- | Hexamethyl- | Polydimethyl- |
| silica | | disilazane | disilazane | siloxane |
| | Volume average | 12 | 12 | 25 |
| | particle diameter | | | |
| | (Dv) (nm) | | | |

| | | | |
|---|---|---|---|
| Charging stability | B | B | B |
| Image quality | B | B | B |
| Image granularity and image sharpness | A | B | B |
| Heat resistant storage stability | B | B | B |

| | | Example | | |
|---|---|---|---|---|
| | | 4 | 5 | 6 |
| Pseudoboehmite | Name | AB | AC | AD |
| | Average particle | 120 | 5 | 135 |
| | diameter (median | | | |
| | diameter) (nm) | | | |
| | Surface treatment | Hexamethyl- | Polydimethyl- | Hexamethyl- |
| | | disilazane | siloxane | disilazane |
| | Amount relative | 1 | 1 | 1 |
| | to toner base | | | |
| | particles (%) | | | |
| Hydrophobic | Surface treatment | Polydimethyl- | Hexamethyl- | Polydimethyl- |
| silica | | siloxane | disilazane | siloxane |
| | Volume average | 10 | 12 | 10 |
| | particle diameter | | | |
| | (Dv) (nm) | | | |

| | | | |
|---|---|---|---|
| Charging stability | B | C | C |
| Image quality | B | B | B |
| Image granularity and image sharpness | B | C | C |
| Heat resistant storage stability | B | B | B |

TABLE 3

| | | Comparative Example | | |
|---|---|---|---|---|
| | | 1 | 2 | 3 |
| Amorphous | Name | BA | | |
| aluminum | Average particle | 108 | | |
| hydroxide | diameter (median | | | |
| | diameter) (nm) | | | |
| | Surface treatment | Polydimethyl- | | |
| | | siloxane | | |
| | Amount relative | 1 | | |
| | to toner base | | | |
| | particles (%) | | | |
| Bayerite | Name | | BB | |
| | Average particle | | 25 | |
| | diameter (median | | | |
| | diameter) (nm) | | | |
| | Surface treatment | | Polydimethyl- | |
| | | | siloxane | |
| | Amount relative | | 1 | |
| | to toner base | | | |
| | particles (%) | | | |
| Hydrargillite | Name | | | BC |
| | Average particle | | | 12 |
| | diameter (median | | | |
| | diameter) (nm) | | | |
| | Surface treatment | | | Hexamethyl- |
| | | | | disilazane |
| | Amount relative | | | 1 |
| | to toner base | | | |
| | particles (%) | | | |
| Hydrophobic | Surface treatment | Hexamethyl- | Hexamethyl- | Hexamethyl- |
| silica | | disilazane | disilazane | disilazane |
| | Volume average | 12 | 12 | 12 |
| | particle diameter | | | |
| | (Dv) (nm) | | | |

| | | | |
|---|---|---|---|
| Charging stability | D | D | D |
| Image quality | B | B | C |
| Image granularity and image sharpness | B | C | C |
| Heat resistant storage stability | C | B | C |

It was found from the results of Table 2 and Table 3 that all the toners of Examples 1 to 6 were more excellent in charging stability, image quality, image granularity, image sharpness, and heat resistant storage stability compared to Comparative Examples 1 to 3.

Aspects of the present disclosure are as follows, for example.

<1>A toner including

inorganic particles,

wherein the inorganic particles include silica and at least one selected from the group consisting of boehmite and pseudoboehmite.

<2>The toner according to <1>,

wherein the boehmite and the pseudoboehmite are a product obtained by hydrolyzing aluminum alkoxide.

<3>The toner according to <1>or <2>,

wherein the toner includes toner base particles, and

an amount of the at least one selected from the group consisting of boehmite and pseudoboehmite is 0.5 parts by mass or more but 10 parts by mass or less relative to 100 parts by mass of the toner base particles.

<4>The toner according to any one of <1>to <3>,

wherein the at least one selected from the group consisting of boehmite and pseudoboehmite is at least one selected from the group consisting of silicon-containing boehmite and silicon-containing pseudoboehmite.

<5>The toner according to any one of <1>to <4>,

wherein the boehmite and the pseudoboehmite each have an average particle diameter of 5 nm or more but 135 nm or less.

<6>A toner stored container including:

the toner according to any one of <1>to <5>; and

a container,

the toner being stored in the container.

<7>A developer including

the toner according to any one of <1>to <5>.

<8>A developer including:

the toner according to any one of <1>to <5>; and

a carrier.

<9>A developer stored container including:

the developer according to <7>or <8>; and

a container,

the developer being stored in the container.

<10>A process cartridge including:

an electrostatic latent image bearer; and

a developing unit containing the developer according to <7>or <8> and configured to develop, using the developer, an electrostatic latent image formed on the electrostatic latent image bearer to form a visible image, the process cartridge being detachably mounted in a body of an image forming apparatus.

<11>An image forming apparatus including;

an electrostatic latent image bearer;

a charging unit configured to charge a surface of the electrostatic latent image bearer;

an exposing unit configured to expose the surface of the electrostatic latent image bearer charged to form an electrostatic latent image;

a developing unit containing the developer according to <7>or <8> and configured to develop the electrostatic latent image using the developer to form a visible image;

a transfer unit configured to transfer the visible image to a recording medium; and

a fixing unit configured to fix an image transferred on the recording medium.

The toner according to any of <1>to <5>, the toner stored container according to <6>, the developer according to <7>or <8>, the developer stored container according to <9>, the process cartridge according to <10>, and the image forming apparatus according to <11> can solve the existing problems in the art and can achieve the object of the present disclosure.

What is claimed is:

1. A toner comprising
inorganic particles,
wherein the inorganic particles include silica and at least one selected from the group consisting of boehmite and pseudoboehmite.

2. The toner according to claim 1,
wherein the boehmite and the pseudoboehmite are a product obtained by hydrolyzing aluminum alkoxide.

3. The toner according to claim 1,
wherein the toner includes toner base particles, and
an amount of the at least one selected from the group consisting of boehmite and pseudoboehmite is 0.5 parts by mass or more but 10 parts by mass or less relative to 100 parts by mass of the toner base particles.

4. The toner according to claim 1,
wherein the at least one selected from the group consisting of boehmite and pseudoboehmite is at least one selected from the group consisting of silicon-containing boehmite and silicon-containing pseudoboehmite.

5. The toner according to claim 1,
wherein the boehmite and the pseudoboehmite each have an average particle diameter of 5 nm or more but 135 nm or less.

6. A toner stored container comprising:
the toner according to claim 1; and
a container,
the toner being stored in the container.

7. A developer comprising
the toner according to claim 1.

8. A developer comprising:
the toner according to claim 1; and
a carrier.

9. A developer stored container comprising:
the developer according to claim 7; and
a container,
the developer being stored in the container.

10. A process cartridge comprising:
an electrostatic latent image bearer; and
a developing unit containing the developer according to claim 7 and configured to develop, using the developer, an electrostatic latent image formed on the electrostatic latent image bearer to form a visible image, the process cartridge being detachably mounted in a body of an image forming apparatus.

11. An image forming apparatus comprising:
an electrostatic latent image bearer;
a charging unit configured to charge a surface of the electrostatic latent image bearer;
an exposing unit configured to expose the surface of the electrostatic latent image bearer charged to form an electrostatic latent image;
a developing unit containing the developer according to claim 7 and configured to develop the electrostatic latent image using the developer to form a visible image;
a transfer unit configured to transfer the visible image to a recording medium; and
a fixing unit configured to fix an image transferred on the recording medium.
